(19) United States
(12) Patent Application Publication
(10) Pub. No.: US 2024/0125017 A1
(43) Pub. Date: Apr. 18, 2024

(54) MULTI-LAYER KNIT FABRICS HAVING IMPROVED FILTER PROPERTIES AND USES THEREOF

(71) Applicant: SENLINTEX CO.,LTD., Seoul (KR)

(72) Inventor: Yong Chul Kim, Pocheon-si (KR)

(73) Assignee: SENLINTEX CO.,LTD., Seoul (KR)

(21) Appl. No.: 17/970,522

(22) Filed: Oct. 20, 2022

(30) Foreign Application Priority Data
Oct. 12, 2022 (KR) 10-2022-0130698

(51) Int. Cl. D04B 1/24; D03D 15/44; D04B 9/42

(52) U.S. Cl. CPC D04B 1/24; D03D 15/44; D04B 9/42; D10B 2403/033; D10B 2501/04

(57) ABSTRACT

Disclosed are multi-layer knit fabrics having improved filter properties when applied as fabrics for a mask, including a surface knit fabric, a back knit fabric, and a connection loop, and a mask filter and a mask using the same. The present disclosure provides multi-layer knit fabrics including a surface knit fabric, a back knit fabric, and a connection loop for binding the surface knit fabric and the back knit fabric, in which the surface knit fabric, the back knit fabric, and the connection loop are made of C-shaped yarns, and the connection loop includes a first connection loop and a second connection loop, which are formed in a zigzag shape, and also provides a mask filter and a mask using the same.

### CROSS-REFERENCE TO RELATED APPLICATION

This application claims priority under 35 U.S.C. § 119(a) to Korean Patent Application No. 10-2022-0130698 filed on Oct. 12, 2022, the entire contents of which are incorporated herein by reference.

### BACKGROUND

### (a) Technical Field

The present disclosure relates to multi-layer knit fabrics and uses thereof, and more particularly, to multi-layer knit fabrics having improved filter properties and uses thereof.

The present disclosure is derived from studies conducted by the following support.
Project Number: BT210183
Supporting organization: Seoul
Research Management Organization: Seoul Business Agency
Research Business Name: Biomedical technology commercialization support project
Research Subject Name: KF94 functional fabric sewing type quarantine mask with virus killing function using copper yarn
Managing Department: SENRIN TEX Co., Ltd.
Research Period: Sep. 1, 2021 to Aug. 31, 2022

### (b) Background Art

Recently, as problems caused by Corona virus as well as fine dust have emerged as a global solution, the importance of masks is being highlighted above all.

In general, performance certification masks such as KF80, KF94, and KF99 apply non-woven filter materials, but there is a problem in that it is difficult to reuse the masks due to deterioration of filter performance during cleaning or washing.

On the other hand, as a mask in the form of knit fabrics, there has been proposed a seamless mask manufactured by a seamless circular knitting machine. The mask in the form of knit fabrics has an advantage of being reusable unlike the mask in the form of a non-woven fabric, but there is a problem in that there is low collection performance of dust as well as viruses and bacteria.

There are disclosed three-layer knit fabrics in which a surface knit fabric and a back knit fabric are bound with a vertical loop using a double circular knitting machine. In Korean Laid-open Patent Publication No. 2002-0060878, there is disclosed multi-layer woven or knitting fabrics with absorption and dry properties which have a three-layer structure consisting of a hydrophobic surface tissue layer, a hydrophobic back tissue layer, and hydrophilic loops for binding the tissue layers, and are knitted with a double circular knitting machine. In Korean Patent Registration No. 2000730, there is disclosed a multi-layer knit fabric as a material to be applied as an antibacterial mask, including an upper knit fabric; a lower knit fabric including an electrically conductive fiber containing a copper component and a non-conductive fiber containing a copper component; and a vertical knit fabric containing a monofilament yarn fiber.

However, in order to certify the performance of the KF94 level when applied as mask fabrics, reinforcement of filter performance is continuously required.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present disclosure is intended to provide multi-layer knit fabrics with more improved filter properties when applied as mask fabrics, including a surface knit fabric, a back knit fabric, and a connection loop, and a mask filter and a mask using the same.

According to another aspect of the present disclosure, there is provided multi-layer knit fabrics including: a surface knit fabric; a back knit fabric; and a connection loop for binding the surface knit fabric and the back knit fabric, in which the surface knit fabric, the back knit fabric, and the connection loop are made of C-shaped yarns, and the connection loop includes a first connection loop and a second connection loop which are formed in a zigzag shape.

A loop length of the connection loop may be 1.5 to 10 times larger than the loop lengths of the surface knit fabric and the back knit fabric.

The multi-layer knit fabrics may be circular-knitted with a double circular knitting machine of 28 to 40 gauges, and the loop lengths of the surface knit fabric and the back knit fabric may be 1 to 2.5 mm per loop (course), and the loop length of the connection loop is 4.5 to 10 mm per loop (course).

The multi-layer knit fabrics may be compressed to a thickness of ⅕ to ⅔, and thus the compressed thickness may be 1 to 2 mm.

According to another aspect of the present disclosure, there is provided a mask filter including the multi-layer knit fabrics, in which the surface knit fabric is used as an outer direction and the back knit fabric is used as an inner direction.

According to yet another aspect of the present disclosure, there is provided a mask including the multi-layer knit fabrics, in which the surface knit fabric is used as an outer surface and the back knit fabric is used as an inner surface.

According to the present disclosure, in the multi-layer knit fabrics including the surface knit fabric, the back knit fabric and the connection loop, since the multi-layer knit fabrics use all C-shaped yarns and are formed in a zigzag shape of the first and second connection loops, it is possible to maximize a filter effect while using semi-permanently by excluding non-woven materials.

The effects of the present disclosure are not limited to the aforementioned effect, and other effects not mentioned above will be clearly understood to those skilled in the art from the description of the appended claims.

### BRIEF DESCRIPTION OF THE DRAWINGS

FIG. 1 is a view schematically illustrating a vertical cross-section of multi-layer knit fabrics according to the present disclosure;

FIG. 2 is a schematic view illustrating a shape of a C-shaped yarn applied in the present disclosure;

FIG. 3 is a cross-sectional schematic view illustrating a state in which the multi-layer knit fabrics are compressed in the present disclosure; and

FIG. 4 is a schematic view illustrating a state in which the degree of collision or disordered flow of air or materials is increased by distorting the C-shaped yarn according to the compression of the multi-layer knit fabrics in the present disclosure.

### DETAILED DESCRIPTION

Hereinafter, preferred embodiments of the present disclosure will be described in detail with reference to the accompanying drawings. In describing the present disclosure, a detailed description of related known technologies will be omitted if it is determined that the detailed description makes the gist of the present disclosure unclear. In order to clearly explain the present disclosure in the drawings, parts irrelevant to the description are omitted and exaggerated for the convenience of understanding, and throughout the specification, similar reference numerals are designated to similar parts, and directions of detailed configurations illustrated in multi-layer knit fabrics will be described with reference to the drawings. Further, throughout the specification, unless explicitly described to the contrary, when a certain part “comprises” a certain component, it will be understood to further include another component without excluding the other component.

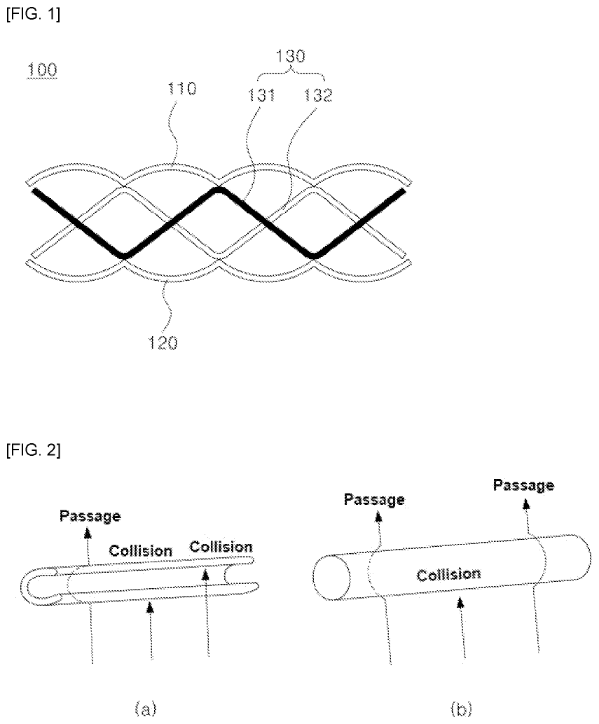

FIG. 1 is a view schematically illustrating a vertical cross-section of multi-layer knit fabrics according to the present disclosure.

Referring to FIG. 1, multi-layer knit fabrics 100 according to the present disclosure include a surface knit fabric 110, a back knit fabric 120, and a connection loop 130 for binding the surface knit fabric 110 and the back knit fabric 120. The surface knit fabric 110, the back knit fabric 120, and the connection loop 130 are made of C-shaped yarns, and the connection loop 130 includes a first connection loop 131 and a second connection loop 132 which are formed in a zigzag shape.

In the present disclosure, ‘knitting’ means weaving a fabric in a circular knitting machine, and knit fabrics or knit fabrics are woven in a knit form, for example, fabrics that are stretched 10 to 30% or more and then restored to its original state.

In the present disclosure, the C-shaped yarn is applied as yarns forming the surface knit fabric 110, the back knit fabric 120, and the connection loop 130. FIG. 2 is a schematic view illustrating a comparison of shapes of a C-shaped yarn (A) and a general yarn (B) applied in the present disclosure.

Referring to FIG. 2, the C-shaped yarn is an open-type yarn having a ‘C’-shaped cross-section, unlike a cylindrical type in which the general yarn is blocked. In the case of the general yarn, in a flow of air or materials passing through the periphery of the yarn, as illustrated in FIG. 2B, except for the air or materials that precisely collide with the center of the yarn, the general yarn has a structure that may easily pass along the circumference of the yarn. In the case of the C-shaped yarn, as illustrated in FIG. 2A, air or materials may easily pass through one side of the yarn like a general yarn, while the flow of air or materials is blocked or changed to a disordered flow by an end elongated from the other side so as to make it not easy for air or materials to pass through the periphery of the yarn, thereby improving filter properties.

Such a C-shaped yarn is well known in the art as a yarn obtained by spinning a cross section in a ‘C’ shape, and for example, may include AEROWARM (trade name) of Hyosung TNC Co., Ltd., and the like. A conventional C-type yarn has been applied to warm clothing, but in the present disclosure, it is intended to suggest its use as a mask fabric.

The connection loop 130 is an intermediate yarn, and generally serves to prevent tissue deformation during compression of the multi-layer knit fabrics 100 by binding one connection loop 130 to one yarn of each of the surface knit fabric 110 and the back knit fabric 120 to impart rigidity.

However, in the present disclosure, there is disclosed a structure in which the connection loop 130 is bound to one yarn of each of the surface knit fabric 110 and the back knit fabric 120 so that the first connection loop 131 and the second connection loop 132 are formed in a zigzag shape, thereby further improving filter properties by strengthening an entangled structure while increasing the density of the intermediate yarn 130.

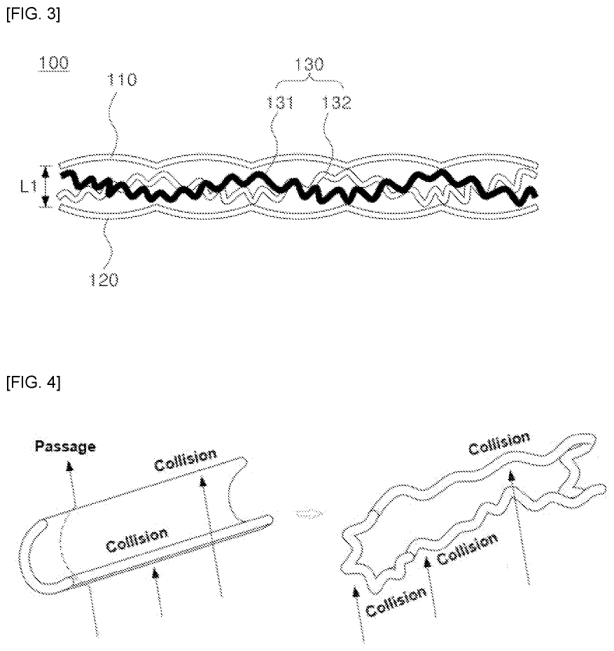

FIG. 3 is a cross-sectional schematic view illustrating a state in which the multi-layer knit fabrics are compressed in the present disclosure.

Referring to FIG. 3, in the present disclosure, in the multi-layer knit fabrics 100, the surface knit fabric 110 and the back knit fabric 120 are spaced apart from each other by the connection loop 130, and for example, a spacing distance L may be 1 to 2 mm. The spacing between the surface knit fabric 110 and the back knit fabric 120 refers to a state that is subjected to a process such as post-processing, for example, refining, and is compressed to a thickness of ⅕ to ⅔, preferably a thickness of ⅜ to ⅔ in a grey fabric state before refining (see FIG. 1) to reduce the spacing distance L. In addition, by compression, the surface knit fabric 110 and the back knit fabric 120, in particular, the connection loop 130 are deformed into a distorted form. Accordingly, as illustrated in FIG. 4, the degree of collision or disordered flow of air or materials passing through the connection loop 130 as the intermediate yarn is increased to further improve filter properties.

In order to maximize the degree of distortion of these intermediate yarns, according to one embodiment of the present disclosure, a loop length of the connection loop 130 is relatively larger than the loop lengths of the surface knit fabric 110 and the back knit fabric 120. That is, the loop length of the connection loop 130 is formed to be 1.5 to 10 times, preferably 1.5 to 5 times, more preferably 2.5 to 4 times larger than the loop lengths of the surface knit fabric 110 and the back knit fabric 120, so that the connection loop 130 as the intermediate yarn is greatly distorted compared to the surface knit fabric 110 and the back knit fabric 120 during compressing, thereby maximizing the filter properties. Furthermore, the loop length may be standardized, and when circular knitting with a double circular knitting machine of 28 to 40 gauges, the loop lengths of the surface knit fabric and the back knit fabric may be 1 to 3 mm, preferably 1.5 to 2.5 mm per loop (course), and the loop length of the connection loop may be 4.5 to 10 mm, preferably 5 to 8 mm per loop (course). Here, the loop length means an unfolded length of one repeated cycle of the yarn to be circular knitted.

In the present disclosure, the multi-layer knit fabrics 100 may be knitted using a conventional double circular knitting machine. The double circular knitting machine and the knitting conditions may be appropriately selected according to a type of fiber used in the surface knit fabric 110, the back knit fabric 120 and the connection loop 130, and for example, conditions of the aforementioned loop length, 80 to 100 feeders, and 28 to 40 gauges may be used. The multi-layer knit fabrics 100 in the form of grey fabric knitted by the double circular knitting machine may be manufactured in the form of final multi-layer knit fabrics through a subsequent refining process, and the refining process may be performed by using methods known in the art, and for example, methods disclosed in Korean Patent Registration Nos. 1925070, 1925063, and 1866418 may be used.

According to an embodiment of the present disclosure, the outer surface of the surface knit fabric 110 may be a water-repellent coating. Since the outer surface of the surface knit fabric 110 is treated with the water-repellent coating, it is possible to suppress the inflow of moisture, and also to block droplets having a diameter of about 4 m or more.

The composition of a water-repellent coating solution used for the water-repellent coating is not particularly limited, and a coating solution used for water-repellent treatment of conventional fiber materials may be used, and for example, a fluorine-based or non-fluorine-based water-repellent coating solution may be used. In addition, the water-repellent coating on the outer surface of the surface knit fabric 110 may be performed using a known knife method or rotary method.

According to an embodiment of the present disclosure, the yarn constituting the multi-layer knit fabrics 100 may be an antibacterial yarn. That is, the surface knit fabric 110, the back knit fabric 120, and the connection loop 130 may all be antibacterial treated yarn, thereby imparting an antibacterial effect to the multi-layer knit fabrics 100.

The method for manufacturing the antibacterial treated yarn is not particularly limited, and yarn prepared by mixing and spinning an antibacterial agent in a spinning process using a known method, for example, a yarn manufacturing chip may be used.

If the multi-layer knit fabrics 100 are applied to filter contamination sources such as fine dust, viruses, bacteria, etc., there is no limitation in its use, but the multi-layer knit fabrics may be preferably applied for a mask filter or a mask.

When applied as the mask filter, as a mask filter including the multi-layer knit fabric 100, the surface knit fabric 110 is used as an outer direction and the back knit fabric 120 is used as an inner direction. When applied as the mask, as a mask including the multi-layer knit fabric 100, the surface knit fabric 110 is used as an outer surface and the back knit fabric 120 is used as an inner surface.

Hereinafter, the present disclosure will be described in more detail through Examples. The yarn specifications used in the following Example and Comparative Example are as follows.

[Yarn Specification]
C-shaped yarn: C-shaped yarn having a cross-sectional shape of FIG. 2A with a thickness of 40 D as a blended yarn of 85 wt % of polyester, 5 wt % of polyamide (PA6) and 10 wt % of polyurethane.
General yarn: General yarn with a thickness of 40 D as a blended yarn of 80 wt % of polyester, 10 wt % of polyamide (PA6) and 10 wt % of polyurethane.

### Example

The C-shaped yarn was fed to a double circular knitting machine (28 gauges) for the surface knit fabric and the back knit fabric, respectively, but the loop lengths of the surface knit fabric and the back knit fabric were adjusted to be circular knitted to 2.5 mm. As the connection loop, the first connection loop and the second connection loop were each fed to be circular knitted with a loop length of 5 mm to circular-knit multi-layer knit fabrics with a thickness of about 3 to 4 mm having the cross-sectional shape of FIG. 1, and then the circular-knitted multi-layer knit fabrics were compressed to manufacture multi-layer knit fabrics with a thickness of about 1.2 to 1.5 mm having the cross-sectional shape of FIG. 3.

### Comparative Example

Multi-layer knit fabrics were manufactured in the same manner as in Example 1, except for using a general yarn instead of the C-shaped yarn in Example 1, and using a single connection loop.

### Test Example

In order to evaluate the filter performance of the manufactured multi-layer knit fabrics, a dust collection efficiency test (NaCl aerosol test and paraffin oil mist test) was performed according to the guidelines for the standard of a health mask of the Ministry of Food and Drug Safety. The test was a method of measuring the amount of sodium chloride and paraffin oil remaining in the air after passing by pressing and heating 1 vol % of a sodium chloride (NaCl) solution and paraffin oil, dispersing the sodium chloride (NaCl) solution and paraffin oil in the air in the form of aerosols and mist having a concentration of 8±4 mg/m³ and a particle size of 0.4 m, and then passing through the filter to be tested at a flow rate of 95 L/min in a direction from the surface knit fabric to the back knit fabric for 30 seconds. The filtration rate was evaluated by performing the method (repeated 3 times, and measured average value), and the results were shown in Table 1 below.

TABLE 1

| | NaCl | Paraffin oil |
|---|---|---|
| | filtration | filtration |
| Classification | rate (%) | rate (%) |
| Example | 96.8 | 92.8 |
| Comparative | 71.7 | 43.3 |
| Example | | |

Referring to Table 1, in the multi-layer knit fabrics including the surface knit fabric, the back knit fabric and the connection loop according to the present disclosure, it can be seen that when all the C-shaped yarns are used and the first and second connection loops are formed in a zigzag shape and then compressed to a predetermined thickness (Example), so that the filter performance close to KF94 grade is implemented.

Hereinabove, preferred embodiments of the present disclosure have been described in detail with reference to the drawings. The aforementioned description of the present disclosure is used for exemplification, and it can be understood by those skilled in the art that the present disclosure can be easily modified in other detailed forms without changing the technical spirit or requisite features of the present disclosure.

The scope of the present disclosure is represented by claims to be described below rather than the detailed description, and it is to be interpreted that the meaning and scope of the claims and all the changes or modified forms derived from the equivalents thereof come within the scope of the present disclosure.

What is claimed is:

1. Multi-layer knit fabrics comprising:
a surface knit fabric;
a back knit fabric; and
a connection loop binding the surface knit fabric and the back knit fabric,
wherein the surface knit fabric, the back knit fabric, and the connection loop are made of C-shaped yarn, and
the connection loop includes a first connection loop and a second connection loop which are formed in a zigzag shape.

2. The multi-layer knit fabrics of claim 1, wherein a loop length of the connection loop is 1.5 to 10 times larger than the loop lengths of the surface knit fabric and the back knit fabric.

3. The multi-layer knit fabrics of claim 1, wherein the multi-layer knit fabrics are circular-knitted with a double circular knitting machine of 20 to 50 gauges, and the loop lengths of the surface knit fabric and the back knit fabric are 1 to 2.5 mm per loop (course), and the loop length of the connection loop is 4.5 to 10 mm per loop (course).

4. The multi-layer knit fabrics of claim 3, wherein the multi-layer knit fabrics are compressed to a thickness of ⅕ to ⅔, and that the compressed thickness is 1 to 2 mm.

5. A mask filter comprising the multi-layer knit fabrics of claim 1, wherein the surface knit fabric is used as an outer direction and the back knit fabric is used as an inner direction.

6. A mask comprising the multi-layer knit fabrics claim 1, wherein the surface knit fabric is used as an outer surface and the back knit fabric is used as an inner surface.
